(19) United States
(12) Patent Application Publication
(10) Pub. No.: US 2026/0177854 A1
(43) Pub. Date: Jun. 25, 2026

(54) DISPLAY DEVICE

(71) Applicant: LG Display Co., Ltd., Seoul (KR)

(72) Inventor: Jaeyeong Kim, Gimpo-si (KR)

(73) Assignee: LG Display Co., Ltd., Seoul (KR)

(21) Appl. No.: 19/195,262

(22) Filed: Apr. 30, 2025

(30) Foreign Application Priority Data
Dec. 20, 2024 (KR) 10-2024-0193074

(51) Int. Cl. G02F 1/1335; G02F 1/133; G02F 1/1333

(52) U.S. Cl. CPC G02F 1/133512; G02F 1/13318; G02F 1/133331

(57) ABSTRACT

A display device includes a display area and a non-display area which encloses the display area and which includes a first sensor area and a second sensor. The display device comprises a first glass substrate, a second glass substrate, a light shielding layer which is disposed on one surface of the second glass substrate so as to correspond to the non-display area and includes a plurality of holes corresponding to the first sensor area and the second sensor area, a first sensor below the first glass substrate corresponding to the first sensor area, a second sensor below the first glass substrate corresponding to the second sensor area, a low-refractive layer on a rear surface of the first glass substrate corresponding to the second sensor area, and an infrared transmissive layer on a rear surface of the low-refractive layer corresponding to the second sensor area.

### CROSS-REFERENCE TO RELATED APPLICATION

This application claims the priority of Korean Patent Application No. 10-2024-0193074, filed on Dec. 20, 2024, in the Korean Intellectual Property Office, the disclosure of which is incorporated herein by reference.

### BACKGROUND

### Field

The present disclosure relates to a display device and, more particularly, to a display device which has a low reflectance and has an improved visibility in an area where a camera and an infrared sensing sensor are disposed.

### Description of the Related Art

Recently, as it enters an information era, a display field which visually expresses electrical information signals has been rapidly developed and in response to this, various display devices having excellent performances, such as thin-thickness, light weight, and low power consumption have been developed.

In the meantime, a multimedia function of a recent display device is being improved. For example, a display device in which an optical electronic device, such as a camera or a sensor, is embedded on a front surface as a default has been developed. Specifically, recently, various biometric sensors, such as a fingerprint recognition sensor, an iris recognition sensor, a motion sensor, or a face recognition sensor, are installed to give a security function to a display device, such as a notebook or a mobile phone.

However, the camera or the sensor disposed on the front surface of the display device may restrict a screen design. Further, to reduce a space occupied by the camera or the sensor on the front surface of the display device, a design including a notch or a punch hole may be applied. Accordingly, the camera or the sensor may include a through hole in a non-display area which is also referred to as a bezel area and may insert a sensor module into the through hole.

### SUMMARY

In the non-display area of the display device, various wiring lines or driving ICs are disposed and a light shielding layer is formed so as not to allow the components to be visible from the outside. The above-described sensors are disposed in the non-display area and in an area where the sensors are disposed, a through hole is formed in a light shielding layer to allow light to transmit to drive the sensors. However, there is a problem in that the sensor area is visible due to the difference in optical characteristics between areas where the light shielding layer and the sensors are disposed.

Accordingly, an object to be achieved by the present disclosure is to improve an exterior appearance quality of a display device by improving a phenomenon that an area where the sensor is disposed in the non-display area is visible.

Another object to be achieved by the present disclosure is to improve a phenomenon that an area in which an infrared sensing sensor is disposed is visible and improve a transmittance of an area in which a camera module is disposed.

Still another object to be achieved by the present disclosure is to improve the durability of an infrared transmissive layer formed in an area where the infrared sensing sensor is disposed.

Objects of the present disclosure are not limited to the above-mentioned objects, and other objects, which are not mentioned above, can be clearly understood by those skilled in the art from the following descriptions.

According to an aspect of the present disclosure, a display device includes a display area and a non-display area which encloses the display area and includes a first sensor area and a second sensor area. The display device includes a first glass substrate, a second glass substrate disposed corresponding to the first glass substrate, a light shielding layer which is disposed on one surface of the second glass substrate so as to correspond to the non-display area and includes a plurality of holes corresponding to the first sensor area and the second sensor area, a first sensor below the first glass substrate corresponding to the first sensor area, a second sensor below the first glass substrate corresponding to the second sensor area, a low-refractive layer on a rear surface of the first glass substrate corresponding to the second sensor area, and an infrared transmissive layer on a rear surface of the low-refractive layer corresponding to the second sensor area. A refractive index of the low-refractive layer is lower than a refractive index of the first glass substrate and a refractive index of the infrared transmissive layer.

According to another aspect of the present disclosure, a display device including a display area and a non-display area which encloses the display area and includes a first sensor area and a second sensor, comprising a first glass substrate, a second glass substrate disposed opposite to the first glass substrate, a light shielding layer which is disposed on one surface of the second glass substrate so as to correspond to the non-display area and includes a plurality of holes corresponding to the first sensor area and the second sensor area, a first sensor below the first glass substrate corresponding to the first sensor area, a second sensor below the first glass substrate corresponding to the second sensor area, an infrared transmissive layer on a rear surface of the first glass substrate corresponding to the second sensor area, and an anti-reflection layer which is disposed below the first glass substrate and the infrared transmissive layer and covers a rear surface and a side surface of the infrared transmissive layer.

Other detailed matters of various example embodiments are included in the detailed description and the drawings.

According to example embodiments of the present disclosure, in the display device, a difference in a color sense and a difference in reflectance between an area where various sensors are disposed and a light shielding layer are reduced so as not to allow the sensor area to be visible from the outside.

According to example embodiments of the present disclosure, in the display device, the difference in a color sense and the difference in reflectance between an infrared transmissive layer and a light shielding layer which are used to drive a face recognition sensor are minimized or reduced so as not to allow a face recognition sensor area to be visible.

According to example embodiments of the present disclosure, in the display device, a light transmittance of an area where the camera module is disposed is improved to improve an optical characteristic.

According to example embodiments of the present disclosure, in the display device, a poor chemical resistance of an infrared transmissive layer which is used to drive the face recognition sensor is reinforced to improve the durability.

The effects according to the present disclosure are not limited to the contents exemplified above, and more various effects are included in the present specification.

Additional features and aspects of the present disclosure are set forth in the description that follows and in part will become apparent from the description or may be learned by practice of the inventive concepts provided herein. Other features and aspects of the inventive concepts may be realized and attained by the structure particularly pointed out in, or derivable from, the written description, claims hereof, and the appended drawings.

It is to be understood that both the foregoing general description and the following detailed description of the present disclosure are by way of example and are intended to provide further explanation of the disclosures as claimed.

### BRIEF DESCRIPTION OF DRAWINGS

The accompanying drawings, which are included to provide a further understanding of the present disclosure and are incorporated in and constitute a part of this application, illustrate aspects of the disclosure and together with the description serve to explain various principles of the present disclosure. In the drawings:

FIG. 1 is a schematic plan view of a display device according to an example embodiment of the present disclosure;

FIG. 2 is a cross-sectional view taken along I-I′ in FIG. 1;

FIG. 3 is a schematic cross-sectional view of a display device according to another example embodiment of the present disclosure;

FIG. 4 is a schematic cross-sectional view of a display device according to still another example embodiment of the present disclosure;

FIG. 5 is a schematic cross-sectional view of a display device according to still another example embodiment of the present disclosure; and

FIG. 6 is a schematic cross-sectional view of a display device according to still another example embodiment of the present disclosure.

### DETAILED DESCRIPTION

Advantages and characteristics of the present disclosure and a method of achieving the advantages and characteristics will be clear by referring to example embodiments described below in detail together with the accompanying drawings. However, the present disclosure is not limited to the example embodiments disclosed herein but can be implemented in various forms. The example embodiments are provided by way of example only so that those skilled in the art can fully understand the disclosures of the present disclosure and the scope of the present disclosure.

The shapes, sizes, ratios, angles, numbers, and the like illustrated in the accompanying drawings for describing the example embodiments of the present disclosure are merely examples, and the present disclosure is not limited thereto. Like reference numerals generally denote like elements throughout the specification. Further, in the following description of the present disclosure, a detailed explanation of known related technologies may be omitted to avoid unnecessarily obscuring the subject matter of the present disclosure. The terms such as “including,” “having,” and “consist of” used herein are generally intended to allow other components to be added unless the terms are used with a more limiting term like “only”. Any references to singular may include plural, and vice versa, unless expressly stated otherwise.

Components are interpreted to include an ordinary error range even if not expressly stated.

Where the position relation between two parts is described using the terms such as “on”, “above”, “below”, and “next”, one or more parts may be positioned between the two parts unless the terms are used with a more limiting term like “immediately” or “directly”.

Where an element or layer is disposed “on” another element or layer, another layer or another element may be interposed directly on the other element or therebetween.

Although the terms “first”, “second”, and the like may be used for describing various components, these components are not confined by these terms. These terms are merely used for referring to one component separately from the other components. Therefore, a first component to be mentioned below may be a second component, and vice versa, in a technical concept of the present disclosure.

Like reference numerals generally denote like elements throughout the specification unless otherwise specified.

A size and a thickness of each component illustrated in the drawing are illustrated for convenience of description, and the present disclosure is not limited to the size and the thickness of the component illustrated.

The features of various embodiments of the present disclosure can be partially or entirely adhered to or combined with each other and can be interlocked and operated in technically various ways, and the embodiments can be carried out independently of or in association with each other.

Hereinafter, a display device according to example embodiments of the present disclosure will be described in detail with reference to accompanying drawings.

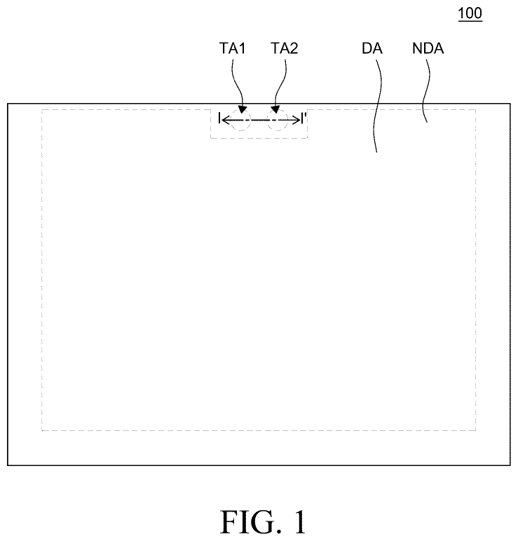

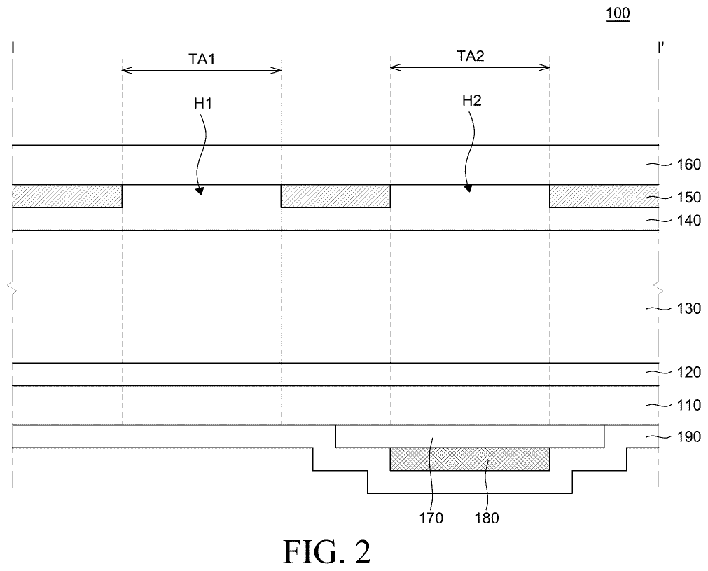

FIGS. 1 and 2 are views for explaining a display device according to an example embodiment of the present disclosure. FIG. 1 is a schematic plan view of a display device according to an example embodiment of the present disclosure, and FIG. 2 is a cross-sectional view taken along I-I′ of FIG. 1.

As shown in FIGS. 1 and 2, the display device according to the example embodiment of the present disclosure includes a first substrate 110, a protection layer 120, a sealant 130, an over coating layer 140, a light shielding layer 150, a second substrate 160, a low-refractive layer 170, an infrared transmissive layer 180, an anti-reflection layer 190, a first sensor S1, and a second sensor S2.

First, as shown in FIG. 1, the display device 100 according to the example embodiment of the present disclosure includes areas defined as a display area DA and a non-display area NDA. The display area DA is an area where a plurality of pixels is disposed to display images. In the display area DA, pixels including an emission area for displaying images and driving elements for driving the pixels may be disposed.

The non-display area NDA encloses around the display area DA. In the non-display area NDA, images are not substantially displayed, and the non-display area is also referred to as a bezel area. In the non-display area NDA, various wiring lines or driving ICs for driving the pixels and the driving elements may be disposed in the display area DA are disposed. The non-display area NDA is blocked by a light shielding layer so as not to allow various wiring lines or driving ICs to be visible from the outside.

The non-display area NDA may include a plurality of sensor areas TA1 and TA2. Each of the plurality of sensor areas TA1 and TA2 may be an area which overlaps one or more sensors. Specifically, in the sensor areas TA1 and TA2, a sensor which provides various functions to the display device may be disposed. For example, the non-display area NDA includes a first sensor area TA1 and a second sensor area TA2. Here, in the first sensor area TA1, an image sensor which captures pictures or videos, that is, a first sensor S1, such as a camera module, is disposed. Further, in the second sensor area TA2, a second sensor S2 which is an infrared sensing sensor, such as a face recognition sensor or a proximity sensor, may be disposed. In contrast, the first sensor may be an infrared sensing sensor, and the second sensor may be an image sensor.

Hereinafter, for the convenience of description, it is assumed that the first sensor S1 is an image sensor and the second sensor S2 is an Infrared sensing sensor. Here, the image sensor may be a camera lens or a camera module.

Even though in FIG. 1, it is illustrated that a plurality of sensor areas TA1 and TA2 is disposed on the top of the display device 100, the present disclosure is not limited thereto. The plurality of sensor areas TA1 and TA2 may be disposed in a different position from a position illustrated in the drawing, depending on the design of the display device or in consideration of a convenience for the use. Further, even though in FIG. 1, it is illustrated that each of the plurality of sensor areas TA1 and TA2 has a circular structure, the present disclosure is not limited thereto. For example, each of the plurality of sensor areas TA1 and TA2 may have an octagonal shape or may have various polygonal shapes in addition thereto.

Even though in FIG. 1, it is illustrated that the non-display area NDA encloses a quadrangular display area DA, shapes and placements of the display area DA and the non-display area NDA are not limited to the example illustrated in FIG. 1. The display area DA and the non-display area NDA may have shapes suitable for a design of an electronic device including the display device 100. For example, an example shape of the display area DA may be a pentagon, a hexagon, a circle, or an oval. In the meantime, in FIG. 1, the non-display area NDA may have a shape which is recessed toward the display area DA. In a position in which the non-display area NDA is recessed, a pixel is not disposed so that the image is not displayed, and it may be defined as a notch area. In the notch area, the first sensor area TA1 and the second sensor area TA2 may be disposed. A notch area in which only an area of the non-display area NDA where the first sensor area TA1 and the second sensor area TA2 are disposed is recessed toward the display area DA may maximize an area of the display area DA.

Hereinafter, with reference to FIG. 2 together, specific components of the display device 100 according to the example embodiment of the present disclosure will be described.

The first substrate 110 is a substrate which supports various elements configuring the display device 100. The first substrate 110 may be formed as a glass substrate. In FIG. 2, the first substrate 110 may be a lower glass substrate. A refractive index of the first substrate 110 may be 1.45 to 1.55 or 1.50.

A circuit layer is disposed on the first substrate 110 corresponding to the display area DA. For example, the circuit layer includes a plurality of gate lines, a plurality of data lines, and a thin film transistor. Specifically, on the first substrate 110, the plurality of gate lines and data lines intersect to define pixels, and a thin film transistor is provided in each intersection of the pixels to be connected to the first electrode formed in each pixel. The thin film transistor may include a plurality of insulating layers, two or more metal layers which are separated from each other with the insulating layer therebetween, and an active layer including a semiconductor material.

The protection layer 120 is disposed on the circuit layer. The protection layer 120 protects the thin film transistor and the wiring line from damages caused during the process of forming a display element layer. Further, the protection layer 120 suppresses the permeation of moisture, oxygen, or foreign materials entering from the outside to the circuit layer. Accordingly, the protection layer 120 may be substantially formed on the front surface of the first substrate 110. The protection layer 120 may be configured as a single layer or a plurality of layers.

As described above, an image sensor is disposed in the first sensor area TA1 and an infrared sensing sensor is disposed in the second sensor area TA2. Even though it is not illustrated in FIG. 2, to ensure a high optical characteristic of the sensor area in which the image sensor and the infrared sensing sensor are disposed, the protection layer 120 may include a through hole in an area overlapping the first sensor area TA1 and the second sensor area TA2. The display element layer is disposed on the protection layer 120. The display element layer is disposed in the display area DA. The display element layer may be a liquid crystal element layer or a light emitting diode layer. The liquid crystal layer includes a liquid crystal layer disposed between a first electrode and a second electrode. The liquid crystal element layer displays an image by adjusting a light transmittance of the liquid crystal using an electric field formed by applying a voltage to the first electrode and the second electrode. The liquid crystal element layer is not a self-emitting display device so that a back light unit is provided on a rear surface of the first substrate 110 corresponding to the liquid crystal element layer. The light emitting diode layer includes an emission layer disposed between the first electrode and the second electrode. When a voltage is applied between the first electrode and the second electrode, the emission layer forms excitons to emit visible ray. The light emitting diode layer is a self-emitting element so that a separate light source, such as a back light unit is not necessary.

Hereinafter, it is described that the display element layer is a liquid crystal element layer, but this is just for convenience of description so that the present disclosure is not limited thereto.

The second substrate 160 is disposed on the display element layer. The second substrate 160 is opposite to the first substrate 110. The second substrate 160 includes one surface opposite to the first substrate 110 and the other surface which is opposite to the one surface. The light shielding layer 150 is disposed on one surface of the second substrate 160 corresponding to the non-display area NDA. The second substrate 160 may be formed as a glass substrate, like the first substrate 110. In FIG. 2, the second substrate 160 may be an upper glass substrate. A refractive index of the second substrate 160 may be 1.45 to 1.55 or 1.50.

The light shielding layer 150 is disposed on one surface of the second substrate 160. The light shielding layer 150 does not allow various wiring lines or driving ICs which are disposed in the non-display area NDA to be visible to the outside. Further, the light shielding layer 150 reduces a reflectance of the display device by absorbing external light to improve the display quality.

The light shielding layer 150 may be formed of a material which is capable of blocking and absorbing light. For example, the light shielding layer 150 may be a black matrix BM which includes a black material or is usually used for a display process. Specifically, the light shielding layer 150 may be formed of ink including a black dye, a binder resin, a solvent, and a dispersant. As the black dye, carbon black, channel black, furnace black, thermal black, or lamp black may be used.

The light shielding layer 150 includes a first hole H1 and a second hole H2 corresponding to the first sensor area TA1 and the second sensor area TA2. As described above, the non-display area NDA includes the first sensor area TA1 and the second sensor area TA2 and in the first sensor area TA1, an image sensor is disposed and in the second sensor area TA2, an Infrared sensing sensor is disposed.

The image sensor is driven by collecting external light and converting the light into images so that the first sensor area TA1 in which the image sensor is disposed requires a high light transmittance in a visible ray range. Therefore, the light shielding layer 150 includes a first hole H1 which passes through the light shielding layer 150 in a thickness direction in an area corresponding to the first sensor area TA1 so that a high visible ray transmittance is ensured.

The infrared sensing sensor senses an infrared energy of the outside to convert the infrared energy into images or videos. For example, the infrared sensing sensor senses an infrared energy of the outside to recognize a user's face. Therefore, the second sensor area TA2 in which the infrared sensing sensor is disposed requires a predetermined level or higher of IR transmittance to sense the IR energy of the outside. Therefore, the light shielding layer 150 includes a second hole H2 which passes through the light shielding layer 150 in a thickness direction in an area corresponding to the second sensor area TA2.

The over coating layer 140 is disposed on one surface of the light shielding layer 150 which is opposite to the first substrate 110. The over coating layer 140 is disposed to be filled in the first hole H1 and the second hole H2 provided in the light shielding layer 150. Therefore, the over coating layer covers steps caused by the first hole H1 and the second hole H2 provided in the light shielding layer 150 to planarize one surface of the light shielding layer 150. The over coating layer 140 may be disposed so as to correspond to the non-display area NDA or disposed on a front surface of the second substrate 160 as another example.

The over coating layer 140 may be formed of silicon resin or acrylic resin. Such resins have excellent optical characteristics. Therefore, the resins do not degrade the optical characteristics of the sensors disposed in the first sensor area TA1 and the second sensor area TA2.

The sealant 130 is disposed between the first substrate 110 and the second substrate 160. The sealant 130 is disposed between the first substrate 110 and the second substrate 160 so as to correspond to the non-display area NDA. Therefore, the sealant 130 overlaps the non-display area NDA. However, at least a part of the sealant 130 may overlap at least a part of the display area DA without being limited thereto.

The sealant 130 is disposed so as to enclose the display element layer disposed in the display area DA. Therefore, the sealant 130 suppresses the leakage of the liquid crystal layer. Further, the sealant 130 suppresses the moisture or oxygen entering from the outside from permeating into the display element layer to suppress degradation of the display element layer.

The sealant 130 is disposed so as to be filled in a space between the first substrate 110 and the second substrate 160 in the non-display area NDA. A top surface of the sealant 130 is disposed so as to be in contact with the over coating layer 140. A bottom surface of the sealant 130 is in contact with the top surface of the protection layer 120 disposed on the first substrate 110. Further, the bottom surface of the sealant 130 is in contact with the top surface of the first substrate 110 exposed by the through hole provided in the protection layer 120. Therefore, the sealant 130 bonds the first substrate 110 and the second substrate 160.

Even though it is not illustrated in the drawing, a touch sensor layer which gives a touch sensing function to the display device 100 may be disposed on the other surface of the second substrate 160.

As described above, in the display device 100 according to the example embodiment of the present disclosure, the first sensor S1 is disposed in the first sensor area TA1 as an image sensor and the second sensor S2 is disposed in the second sensor area TA2 as an infrared sensing sensor.

The image sensor may be disposed on the rear surface of the first substrate 110 corresponding to the first sensor area TA1. The image sensor includes a camera module which captures photographs or videos. Accordingly, the first sensor area TA1 needs to transmit light in a visible ray range so that it has excellent visible ray transmittance.

In the meantime, the infrared sensing sensor is disposed on the rear surface of the first substrate 110 corresponding to the second sensor area TA2. The infrared sensing sensor is a sensor which gives a security function to the display device 100. A performance of the image sensor, such as a camera module, greatly depends on a distance and external luminous intensity, but the infrared sensing sensor is advantageous to operate in a contactless manner and has a long-distance recognition function. The infrared sensing sensor may include an infrared camera module. The infrared camera module acquires an infrared ray emitted from an object to convert the infrared ray into images so that the infrared camera module is advantageous not to be greatly affected by the external luminous intensity, but recognize in an environment where there is substantially no light. Therefore, as the infrared sensing sensor which provides the security function, the infrared camera module is used.

The infrared transmissive layer 180 is disposed between the first substrate 110 and the second sensor S2 so as to correspond to the second sensor area TA2. Specifically, the infrared transmissive layer 180 is disposed to be in contact with the rear surface of the low-refractive layer 170 so as to correspond to the second sensor area TA2. The infrared transmissive layer 180 is disposed so as to overlap the second sensor area TA2. The infrared transmissive layer 180 is disposed so as to completely overlap the second hole H2 of the light shielding layer 150 corresponding to the second sensor area TA2. However, the infrared transmissive layer 180 may be formed to have a larger area than the second sensor area TA2 and the second hole H2 of the light shielding layer 150 without being limited thereto.

The infrared transmissive layer 180 may be formed of a material which transmits the infrared ray while blocking and absorbing at least a part of the visible ray. Specifically, the infrared transmissive layer 180 may include a black material, for example, a black dye (dye type). The infrared transmissive layer 180 includes a black material to suppress reflection from the external light and suppress visible ray from being emitted or leaked from the inside to the outside. Simultaneously, the infrared transmissive layer 180 needs to transmit the infrared ray so that the infrared ray from the outside transmits the inside to be transmitted to the infrared sensing sensor. For example, the infrared transmissive layer 180 may have a transmittance of 10% or lower in a wavelength range of 680 nm or lower and may have a transmittance of 50%, or 80%, or 90% or higher in a wavelength range of 700 nm or lower, but is not limited thereto.

The refractive index of the infrared transmissive layer 180 may be 1.6 or higher, or 1.6 to 2.0, or 1.6 to 1.8, but is not limited thereto.

The infrared transmissive layer 180 is an infrared sensing sensor to have a thickness to transmit the infrared ray and block the visible ray. For example, a thickness of the infrared transmissive layer 180 may be 10 μm or lower, but is not limited thereto.

The low-refractive layer 170 is disposed to be in contact with the rear surface of the first substrate 110 so as to correspond to the second sensor area TA2. The infrared transmissive layer 180 is disposed between the first substrate 110 and the infrared transmissive layer 180. The infrared transmissive layer 180 is disposed so as to completely overlap the second hole H2 of the light shielding layer 150 corresponding to the second sensor area TA2. However, the infrared transmissive layer 180 may be formed to have a larger area than the second sensor area TA2 and the second hole H2 of the light shielding layer 150 without being limited thereto.

The low-refractive layer 170 minimizes a difference in reflectance between the infrared transmissive layer 180 used to drive the infrared sensing sensor and the light shielding layer 150 which defines the plurality of sensor areas TA1 and TA2 so as not to allow the second sensor area to be visible from the outside.

Specifically, as described above, the light shielding layer 150 disposed on the second substrate 160 and the infrared transmissive layer 180 disposed on the rear surface of the low-refractive layer 170 are formed in black. However, the infrared transmissive layer 180 is formed with a material which well transmits the infrared ray so that a color coordinate is shifted to red, more than the light shielding layer 150, and the reflectance is different from that of the light shielding layer 150. As described above, there is a problem in that the second sensor area TA2 is visible from the outside due to the difference in color coordinate and the difference in reflectance between the light shielding layer 150 and the infrared transmissive layer 180.

In the display device 100 according to the example embodiment of the present disclosure, the low-refractive layer 170 has a transmittance lower than the infrared transmissive layer 180 and the first substrate 110. For example, a refractive index of the low-refractive layer 170 may be 1.2 to 1.4, but is not limited thereto. If the refractive index of the low-refractive layer 170 satisfies the above-mentioned range, the difference in color sense and the difference in reflectance between the infrared transmissive layer 180 and the light shielding layer 150 may be minimized.

The following Table 1 represents reflectance Y (%) of a specimen in which a light shielding layer is formed on a glass substrate with a light shielding layer material and a specimen in which an infrared transmissive layer 180 (n=1.73) is formed on a glass substrate (n=1.50) with infrared transmissive ink. Together with this, a reflectance of a specimen in which a low-refractive layer 170 (n=1.35) is disposed between the glass substrate and the infrared transmissive layer is also represented.

TABLE 1

| Classification | Reflectance, Y |
|---|---|
| Glass substrate/Light shielding layer | 4.0% |
| Glass substrate/infrared transmissive layer | 0.51% |
| Glass substrate/Low-refractive layer/infrared | 1.52% |
| transmissive layer | |

As seen from Table 1, a difference of reflectance between the light shielding layer 150 disposed on the glass substrate and the infrared transmissive layer 180 is 3% or higher so that the second sensor area TA2 may be easily visible from the outside. However, the low-refractive layer 170 was added between the glass substrate and the infrared transmissive layer 180 so that the reflectance of the infrared transmissive layer 180 was increased from 0.51% to 1.52%. By doing this, the difference in reflectance between the light shielding layer 150 and the infrared transmissive layer 180 is reduced so that the second sensor area in which the infrared sensing sensor is disposed is not visible from the outside. In the meantime, the low-refractive layer 170 may be formed of a transparent resin having a low refractive index. For example, the low-refractive layer 170 may be formed of a transparent resin having a relatively low refractive index, such as fluorine resin or silicon resin, but is not limited thereto. Further, the low-refractive layer 170 may be formed of fluorinated urethane (meth)acrylate or polydimethylsiloxane (PDMS), but is not limited thereto. Further, to implement a refractive index to be lower, the low-refractive layer 170 may further include inorganic particles having a hollow structure or a porous structure.

Specifically, the low-refractive layer 170 may include a polymer, a monomer, and an additive.

The polymer may include fluorinated urethane (meth)acrylate and polysilsesquioxane compounds. The polymer including fluorinated urethane (meth)acrylate and polysilsesquioxane allows the low-refractive layer 170 to maintain a ductility after being hardened. Further, the polymer including fluorinated urethane (meth)acrylate and polysilsesquioxane has a high light transmittance of 80% or higher or 90% or higher to have excellent optical characteristic. The fluorinated urethane (meth)acrylate includes a group containing fluorine in molecules and polysilsesquioxane is a silicon-based material to contribute to realization of a low refractive characteristic. The fluorinated urethane (meth)acrylate includes a (per)fluoropolyether group in the molecule. The (per)fluoropolyether group is a functional group having a low refractive index to maintain a refractive index of the low-refractive layer 170 to be sufficiently low.

Polysilsesquioxane contributes to securing a desired level of the refractive index of the low-refractive layer 170. For example, polysilsesquioxane may be represented by the general formula (RSiO_{1.5})ₙ. Polysilsesquioxane may have various structures, such as a random type, a ladder type, a cage type and a partial cage type. For example, polysilsesquioxane may be polyhedral oligomeric silsesquioxane (POSS) having a cage structure.

The monomer may serve as a cross linking agent during the process of hardening the composition for forming the low-refractive layer 170. The monomer facilitates the control of the viscosity of the composition to provide the convenience in the process. When the polymer and the monomer are included to be polymerized to form the low-refractive layer 170, the wettability and the coatability may be improved. Therefore, the adhesive strength between the low-refractive layer 170 and the first substrate 110 is improved and the low-refractive layer 170 which is uniform and has a high flatness may be formed. Further, when the polymer and the monomer are used together, the shrinkage during the hardening is suppressed so that the increase of the refractive index may be suppressed.

The monomer includes alkyl (meth)acrylate and fluorinated (meth)acrylate. The compound has a low refractive index of 1.4 or lower and easily implements low-refractive index and improves the adhesive strength with the first substrate 110. For example, alkyl (meth)acrylate may be (meth)acrylate including an alkyl group having 1 to 20 carbon atoms. Specifically, for example, alkyl (meth)acrylate may be selected from ethyl (meth)acrylate, butyl (meth)acrylate, 2-ethyl hexyl (meth)acrylate, 2-(2-ethoxyethoxy) ethyl (meth)acrylate, and 2-[2-(2-methoxyethoxy) ethoxy]ethyl (meth)acrylate, but is not limited thereto. The fluorinated (meth)acrylate may be (meth)acrylate containing the (per)fluoroalkyl group. For example, fluorinated (meth)acrylate may be selected from 2-perfluorohexyl ethyl (meth)acrylate and 3-perfluorohexyl propyl (meth)acrylate, but is not limited thereto.

The additive may be particles which reduce a refractive index of the low-refractive layer 170. For example, the additive may be fluorine-modified inorganic particles. The fluorine-modified inorganic particles control the refractive index of the low-refractive layer to be lower to give an ultra-low refractive property.

The inorganic particles may be spherical. As another example, the inorganic particles may have a hollow or porous structure. When the inorganic particles have a hollow or porous structure, the refractive index of the low-refractive layer 170 may be implemented to be lower. For example, the inorganic particles may be silica.

Surfaces of the inorganic particles are modified with a fluorinated compound. The fluorine-modified inorganic particles have hydrophobicity and have compatibility with a fluorinated material-based polymer matrix. Accordingly, the fluorine-modified inorganic particles may be evenly and uniformly dispersed in the polymer matrix. By doing this, the refractive index of the low-refractive layer 170 is implemented to be low without increasing a haze of the low-refractive layer 170, thereby providing an advantage of an excellent optical property.

For example, the inorganic particles may be surface-modified with (meth)acrylate including the (per)fluoroalkyl group. A (meth)acrylate group of the (meth)acrylate containing the (per)fluoroalkyl group is bonded to the surface of the inorganic particle and thus the (per)fluoroalkyl group encloses the inorganic particle surface. Therefore, the inorganic particle surface shows a hydrophobicity due to the (per)fluoroalkyl group.

A thickness of the low-refractive layer 170 may be adjusted according to a position of the infrared sensing sensor and a thickness of the infrared transmissive layer 180. Specifically, the infrared sensing sensor is preferably disposed to be spaced apart from the first substrate 110 of the display device 100 by approximately 100 μm in consideration of transmission and interference of the infrared ray. Therefore, in consideration of the thickness of the infrared transmissive layer 180 and the anti-reflection layer 190, the thickness of the low-refractive layer 170 may be 100 μm or lower or 90 μm to 100 μm, but is not limited thereto.

The anti-reflection layer 190 is disposed below the first substrate 110. The anti-reflection layer 190 is disposed below the low-refractive layer 170 and the infrared transmissive layer 180 to cover the low-refractive layer 170 and the infrared transmissive layer 180. Therefore, the anti-reflection layer 190 is disposed to be in contact with the rear surface of the first substrate 110 so as to correspond to the first sensor area TA1 and is disposed to be in contact with the rear surface of the low-refractive layer 170 and the infrared transmissive layer 180 so as to correspond to the second sensor area TA2. Even though in FIG. 2, the anti-reflection layer 190 is continuously formed in the first sensor area TA1 and the second sensor area TA2 as a single layer, but is not limited thereto and may also be separately formed in the first sensor area TA1 and the second sensor area TA2, respectively.

The anti-reflection layer 190 improves the light transmittance in the first sensor area TA1 in which the image sensor is disposed and suppresses the reflection. By doing this, the anti-reflection layer 190 allows external light to easily enter into the display device to help the improvement of the performance of the image sensor and reduce interfacial reflection in the display device. The reflectance of the anti-reflection layer 190 may be 2% or lower or 1% or lower, or 0.5% or lower.

The anti-reflection layer 190 may be formed with an inorganic thin film. The anti-reflection layer 190 may include a plurality of inorganic thin films formed of a material of one or more of MgF₂, CeF₂, ZrO₂, SiO₂, TiO₂, Al₂O₃, and Nb₂O₅. Reflected light reflected from two consecutive inorganic thin films, among the plurality of inorganic thin films, may destructively interfere with each other. The plurality of inorganic thin films may include a first inorganic thin film having a first refractive index and second inorganic thin films which have a second refractive index different from the first refractive index and are alternately laminated with the first inorganic thin film. For example, the anti-reflection layer 190 may include a first inorganic thin film formed of SiO₂ (n=1.5) and a second inorganic thin film formed of Nb₂O₅ (n=2.3). At this time, the anti-reflection layer 190 may have a penta-layered structure in which three first inorganic thin films and two second inorganic thin films are alternately laminated, but is not limited thereto. Generally, when it is considered that the distance between the bottom of the first substrate 110 and the second sensor is 100 μm or smaller, the thickness of the anti-reflection layer 190 may be 10 μm or smaller or 1 μm or smaller. To be more specific, the thickness of each of the first inorganic thin film and the second inorganic thin film may be 1 μm or smaller. The reflectance may vary depending on the thickness of each of the first inorganic thin film and the second inorganic thin film and the thickness of each inorganic thin film may be adjusted according to a reference wavelength.

The anti-reflection layer 190 may be formed of an organic thin film including a moth eye pattern. The moth eye pattern is a mountain shape pattern, and each pattern may include a diameter of 50 nm to 300 nm or 100 nm to 200 nm. Further, an interval between patterns (an interval between mountains or between valleys) may be 200 nm or smaller. At this time, a height of the organic thin film including the moth eye pattern may be 1 μm or smaller. The moth eye pattern, for example, may be formed as a single layer of approximately 500 nm using an aromatic resin, such as polyimide, and using nano-imprint or laser holographic process, but is not limited thereto.

The anti-reflection layer 190 may improve the light transmittance in the visible ray range of the first sensor area TA1 in which the image sensor is disposed and may suppresses the reflection. In the meantime, the anti-reflection layer 190 is disposed so as to enclose the infrared transmissive layer 180 of the second sensor area TA2. The infrared transmissive layer 180 includes a black dye (black type), which has a problem in that it has a poor chemical resistance to be easily melted or erased. In the display device 100 according to the example embodiment of the present disclosure, the anti-reflection layer 190 covers the infrared transmissive layer 180 which is disposed in the second sensor area TA2 to protect the infrared transmissive layer 180 from external stimulus or damage and improve the durability.

In the display device 100 according to the example embodiment of the present disclosure, the low-refractive layer 170 is disposed between the first substrate 110 and the infrared transmissive layer 180 so as to correspond to the second sensor area TA2 in which the infrared sensing sensor is disposed. Therefore, the second sensor area TA2 is suppressed from being visible due to the difference in reflectance between the light shielding layer 150 disposed on the second substrate 160 and the infrared transmissive layer 180 and the external appearance characteristic may be improved. To suppress the visibility difference between the light shielding layer 150 and the infrared transmissive layer 180 due to the infrared transmissive layer 180 having a reflectance lower than the light shielding layer 150, the low-refractive layer 170 having a small refractive index is disposed between the light shielding layer 150 and the infrared transmissive layer 180. Therefore, the difference in reflectance between the light shielding layer 150 and the infrared transmissive layer 180 may be reduced.

In the meantime, in the display device 100 according to the example embodiment of the present disclosure, the anti-reflection layer 190 is disposed in the first sensor area TA1 in which the image sensor is disposed to improve the light transmittance of the first sensor area TA1. Here, the anti-reflection layer 190 extends to the second sensor area TA2 to cover the infrared transmissive layer 180 to protect the infrared transmissive layer 180 having a poor chemical resistance.

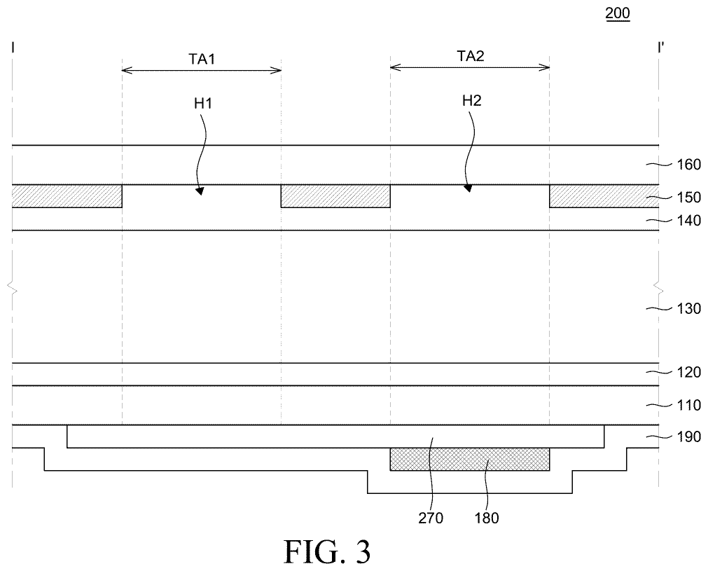

FIG. 3 is a schematic cross-sectional view of a display device according to another example embodiment of the present disclosure. A display device 200 illustrated in FIG. 3 is substantially the same as the display device 100 illustrated in FIGS. 1 and 2 except for a structure in which a low-refractive layer 270 is disposed so that a redundant description will be omitted.

The low-refractive layer 270 is disposed to be in contact with the rear surface of the first substrate 110 so as to correspond to the first sensor area TA1 and the second sensor area TA2. The infrared transmissive layer 180 extends from the second sensor area TA2 to the first sensor area TA1 to be configured as a single layer.

The low-refractive layer 270 may minimize a difference in reflectance between the infrared transmissive layer 180 used to drive the infrared sensing sensor and the light shielding layer 150 which defines the plurality of sensor areas TA1 and TA2. Further, the low-refractive layer 270 is disposed in the second sensor area TA2 in which the image sensor is disposed to improve the light transmittance in the visible ray range in the second sensor area TA2. At this time, the low-refractive layer 270 is formed to be simultaneously disposed in the first sensor area TA1 and the second sensor area TA2 to promote the convenience of the process.

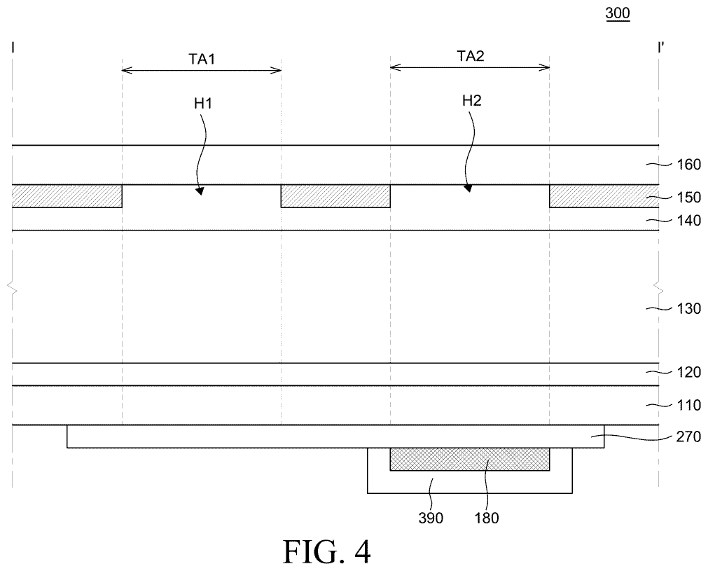

FIG. 4 is a schematic cross-sectional view of a display device according to another example embodiment of the present disclosure. A display device 300 illustrated in FIG. 4 is substantially the same as the display device 200 illustrated in FIG. 3 except for a configuration of an anti-reflection layer 390 so that redundant description will be omitted.

The anti-reflection layer 390 is disposed below the infrared transmissive layer 180 to cover the infrared transmissive layer 180. At this time, the anti-reflection layer 390 does not cover a rear surface of the low-refractive layer 270, but cover a rear surface and a side surface of the infrared transmissive layer 180. The anti-reflection layer 390 is disposed so as to cover the infrared transmissive layer 180 to reduce a reflectance of the second sensor area TA2 and protect the infrared transmissive layer 180.

A material and a composition which configure the anti-reflection layer 390 in the display device 300 illustrated in FIG. 4 may be different from those of the anti-reflection layer 190 in the display device 200 illustrated in FIG. 3. That is, the anti-reflection layer 190 of the display device 300 illustrated in FIG. 4 may be configured to improve the light transmittance in the infrared range while reducing the light transmittance in the visible ray range to improve the performance of the infrared sensing sensor disposed in the second sensor area TA2. By doing this, the optical characteristic of the second sensor area TA2 may be improved and the durability of the infrared transmissive layer 180 may be improved.

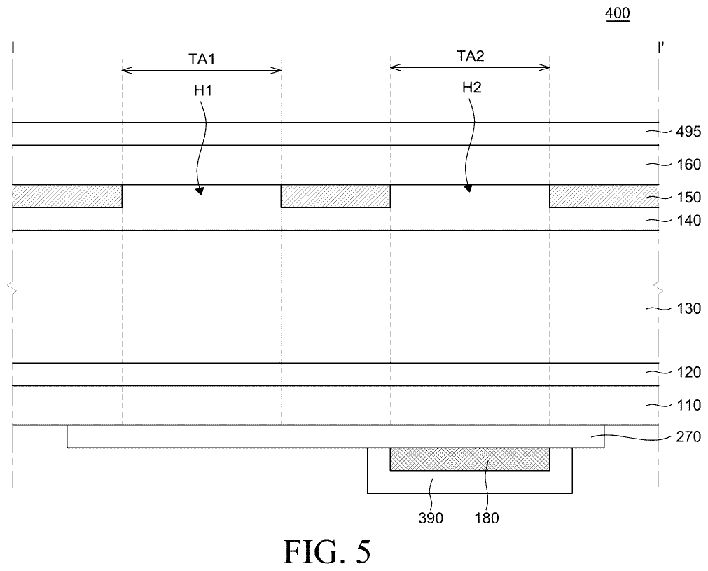

FIG. 5 is a schematic cross-sectional view of a display device according to another example embodiment of the present disclosure. A display device 400 illustrated in FIG. 5 is substantially the same as the display device 300 illustrated in FIG. 4 except that an upper anti-reflection layer 495 is added onto a top surface of the second substrate 160 so that a redundant description will be omitted.

The upper anti-reflection layer 495 is disposed on the top surface of the second substrate 160 so as to correspond to the first sensor area TA1 and the second sensor area TA2. The upper anti-reflection layer 495 improves the light transmittance in the first sensor area TA1 in which the image sensor is disposed and suppresses the reflection. By doing this, the upper anti-reflection layer 495 allows external light to easily enter into the display device 400 to help the improvement of the performance of the camera module and reduce interfacial reflection in the display device 400. The reflectance of the upper anti-reflection layer 495 may be 2% or lower or 1% or lower, or 0.5% or lower.

In the display device 400 illustrated in FIG. 5, the anti-reflection layer 390 disposed below the first substrate 110 is disposed only in the second sensor area TA2 so as to cover the infrared transmissive layer 180. In this case, the anti-reflection layer 190 is not disposed in the first sensor area TA1 so that the upper anti-reflection layer 495 is disposed on the top surface of the second substrate 160 so as to correspond to the first sensor area TA1 to improve the light transmittance in the visible ray range in the first sensor area TA1.

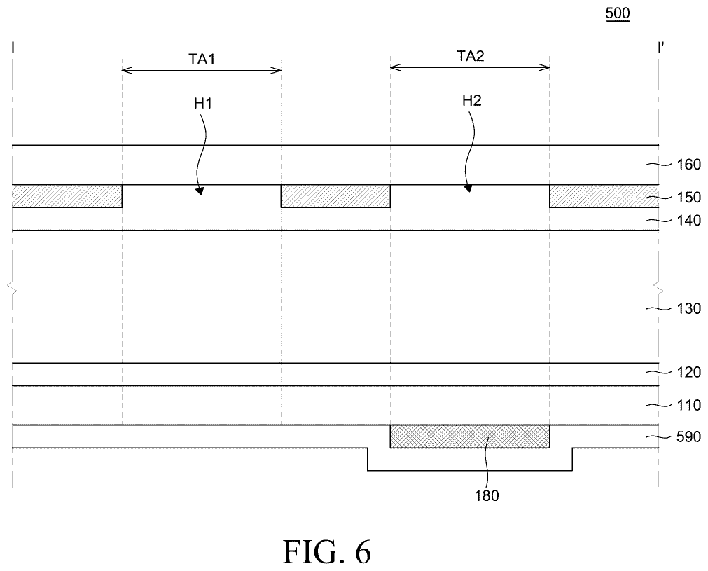

FIG. 6 is a schematic cross-sectional view of a display device according to another example embodiment of the present disclosure. A display device 500 illustrated in FIG. 6 is substantially the same as the display device 100 illustrated in FIG. 2 except that the low-refractive layer 170 is excluded and only an infrared transmissive layer 180 and an anti-reflection layer 590 are disposed below the first substrate 110. Accordingly, a redundant description will be omitted.

Specifically, the infrared transmissive layer 180 is disposed to be in direct contact with the rear surface of the first substrate 110 so as to correspond to the second sensor area TA2. The infrared transmissive layer 180 is disposed so as to overlap the second sensor area TA2. The infrared transmissive layer 180 suppresses reflection from the external light and suppresses visible ray from being emitted or leaked from the inside to the outside. Simultaneously, the infrared transmissive layer 180 may transmit the infrared ray so that the infrared ray from the outside transmits the inside to be transmitted to the infrared sensing sensor.

The anti-reflection layer 590 is disposed below the first substrate 110 and the infrared transmissive layer 180. The anti-reflection layer 590 is disposed below the infrared transmissive layer 180 in the second sensor area TA2 to cover a rear surface and a side surface of the infrared transmissive layer 180. Further, the anti-reflection layer 590 is disposed to be in contact with the rear surface of the first substrate 110 so as to correspond to the first sensor area TA1.

The anti-reflection layer 590 improves the light transmittance in the first sensor area TA1 in which the image sensor is disposed and suppresses the reflection. By doing this, the anti-reflection layer 590 allows external light to easily enter into the display device to help the improvement of the performance of the image sensor and reduce interfacial reflection in the display device. Further, the anti-reflection layer 590 is disposed so as to cover the infrared transmissive layer 180 to protect the infrared transmissive layer 180 having a poor chemical resistance.

Hereinafter, the effects of the present disclosure will be described in more detail with reference to Examples and Comparative Examples. However, the following Examples are set forth to illustrate the present disclosure, but the scope of the present disclosure is not limited thereto.

### Example 1

As illustrated in FIG. 1, a specimen in which a protection layer (n=1.5), an over coating layer (n=1.5), a light shielding layer (a reflectance Y is 5.79%), and an upper glass substrate (n=1.5) were disposed on the lower glass substrate (n=1.5) was prepared. Thereafter, a low-refractive layer which was formed of fluorine resin and had a refractive index of 1.35 was disposed so as to correspond to first and second sensor areas, and an infrared transmissive layer having a refractive index of 1.73 was disposed below the low-refractive layer so as to correspond to the second sensor area.

### Comparative Example 1

A specimen having substantially the same structure as Example 1 except that a low-refractive layer was excluded was manufactured.

### Example 2

A specimen having substantially the same structure as Example 1 except that a reflectance Y of a light shielding layer was 6.38% and a refractive index of a low-refractive layer was 1.31 was manufactured.

### Example 3

A specimen having substantially the same structure as Example 1 except that an anti-reflection layer with a structure in which SiO₂ (n=1.5)/Nb₂O₅ (n=2.3)/SiO₂ (n=1.5)/Nb₂O₅ (n=2.3)/SiO₂ (n=1.5) were sequentially laminated was further disposed below the lower glass substrate so as to simultaneously correspond to the first sensor area and the second sensor area was manufactured.

### Experimental Example

A reflectance and a transmittance of specimens according to Examples 1 to 3 and Comparative Example 1 were measured. The optical characteristic of each specimen was measured with respect to the second substrate. The result thereof was represented in the following Table 2.

TABLE 2

| | Light transmittance in | Reflectance in |
|---|---|---|
| Classification | first sensor area | second sensor area |
| Example 1 | 93.5% | 5.80% |
| Com. Ex. 1 | 92% | 4.51% |
| Example 2 | 93.74% | 6.37% |
| Example 3 | 97.7% | 6.37% |

As seen from Table 2, as compared with Comparative Example 1, in Example 1, a light transmittance in the visible ray range in the first sensor area was improved. Further, in Example 1, a reflectance in the second sensor area was 5.80% so that it was confirmed that the difference in reflectance from the light shielding layer was significantly small as compared with Comparative Example 1. Further, in Example 2, a reflectance in the second sensor area was 6.37%, which was similar to the reflectance (6.38) of the light shielding layer. Accordingly, in Examples 1 and 2, a phenomenon that the second sensor area was visible was solved. Further, with reference to Example 3, when the anti-reflection layer was disposed below the lower glass substrate in the first sensor area and the second sensor area, it was confirmed that the light transmittance in the first sensor area in which the image sensor was disposed was significantly improved.

The example embodiments of the present disclosure can also be described as follows:

According to an aspect of the present disclosure, there is provided a display device. The display device including a display area and a non-display area which encloses the display area and includes a first sensor area and a second sensor, comprises a first glass substrate, a second glass substrate disposed corresponding to the first glass substrate, a light shielding layer which is disposed on one surface of the second glass substrate so as to correspond to the non-display area and includes a plurality of holes corresponding to the first sensor area and the second sensor area, a first sensor below the first glass substrate corresponding to the first sensor area, a second sensor below the first glass substrate corresponding to the second sensor area, a low-refractive layer on a rear surface of the first glass substrate corresponding to the second sensor area, and an infrared transmissive layer on a rear surface of the low-refractive layer corresponding to the second sensor area. A refractive index of the low-refractive layer may be lower than a refractive index of the first glass substrate and a refractive index of the infrared transmissive layer.

The refractive index of the low-refractive layer may be in a range from 1.2 to 1.4, and the refractive index of the infrared transmissive layer may be 1.6 or higher.

The low-refractive layer may include fluorine resin or silicon resin, and the fluorine resin may include a group selected from (per)fluoroalkyl, (per)fluoroalkyl vinyl ether, and (per) fluoroalkoxy alkyl.

The low-refractive layer may include polymer, monomer, and an additive, and the polymer may include fluorinated urethane (meth)acrylate and polysilsesquioxane compounds.

The monomer may include alkyl (meth)acrylate and fluorinated (meth)acrylate.

The additive may be inorganic particles modified to (meth)acrylate including (per)fluoroalkyl group.

The additive may be hollow silica particles.

The low-refractive layer may extend from the second sensor area to the first sensor area.

The display device may further comprise an anti-reflection layer which is disposed below the low-refractive layer and the infrared transmissive layer so as to correspond to the second sensor area and has a thickness of 10 μm or smaller.

The anti-reflection layer may cover a rear surface and a side surface of the infrared transmissive layer.

The anti-reflection layer may be a plurality of inorganic thin films formed of any one or more inorganic materials, among MgF₂, CeF₂, ZrO₂, SiO₂, TiO₂, Al₂O₃, and Nb₂O₅.

The anti-reflection layer may have a structure in which a first inorganic thin film formed of a first inorganic material and a second inorganic thin film formed of a second inorganic material different from the first inorganic material are alternately laminated.

The anti-reflection layer may be formed of an organic thin film including a moth eye pattern.

The anti-reflection layer may extend from the second sensor area to the first sensor area.

The display device may further comprise an upper anti-reflection layer on a top surface of the second glass substrate corresponding to the first sensor area and the second sensor area.

A difference in reflectance between the light shielding layer and the infrared transmissive layer may be in a range from 2.0 to 7.0%.

According to another aspect of the present disclosure, there is provided a display device. The display device including a display area and a non-display area which encloses the display area and includes a first sensor area and a second sensor, comprising a first glass substrate, a second glass substrate disposed opposite to the first glass substrate, a light shielding layer which is disposed on one surface of the second glass substrate so as to correspond to the non-display area and includes a plurality of holes corresponding to the first sensor area and the second sensor area, a first sensor below the first glass substrate corresponding to the first sensor area, a second sensor below the first glass substrate corresponding to the second sensor area, an infrared transmissive layer on a rear surface of the first glass substrate corresponding to the second sensor area, and an anti-reflection layer which is disposed below the first glass substrate and the infrared transmissive layer and covers a rear surface and a side surface of the infrared transmissive layer.

The anti-reflection layer may be a plurality of inorganic thin films formed of any one or more inorganic materials, among MgF₂, CeF₂, ZrO₂, SiO₂, TiO₂, Al₂O₃, and Nb₂O₅ or an organic thin film including a moth eye pattern.

The anti-reflection layer may extend from the second sensor area to the first sensor area to be in contact with a rear surface of the first glass substrate.

Although the example embodiments of the present disclosure have been described in detail with reference to the accompanying drawings, the present disclosure is not limited thereto and may be embodied in many different forms without departing from the technical concept of the present disclosure. Therefore, the example embodiments of the present disclosure are provided for illustrative purposes only and are not intended to limit the technical concept of the present disclosure. The scope of the technical concept of the present disclosure is not limited thereto. Therefore, it should be understood that the above-described example embodiments are illustrative in all aspects and do not limit the present disclosure. The protective scope of the present disclosure should be construed based on the following claims and their equivalents, and all the technical concepts in the equivalent scope thereof should be construed as falling within the scope of the present disclosure.

What is claimed is:

1. A display device including a display area and a non-display area which encloses the display area and which includes a first sensor area and a second sensor area, the display device comprising:
a first glass substrate;
a second glass substrate disposed opposite to the first glass substrate;
a light shielding layer which is disposed on one surface of the second glass substrate so as to correspond to the non-display area and includes a plurality of holes corresponding to the first sensor area and the second sensor area;
a first sensor below the first glass substrate corresponding to the first sensor area;
a second sensor below the first glass substrate corresponding to the second sensor area;
a low-refractive layer on a rear surface of the first glass substrate corresponding to the second sensor area; and
an infrared transmissive layer on a rear surface of the low-refractive layer corresponding to the second sensor area,
wherein a refractive index of the low-refractive layer is lower than a refractive index of the first glass substrate and a refractive index of the infrared transmissive layer.

2. The display device according to claim 1, wherein the refractive index of the low-refractive layer is in a range from 1.2 to 1.4, and the refractive index of the infrared transmissive layer is 1.6 or higher.

3. The display device according to claim 1, wherein the low-refractive layer includes fluorine resin or silicon resin, and the fluorine resin includes a group selected from (per)fluoroalkyl, (per)fluoroalkyl vinyl ether, and (per)fluoroalkoxy alkyl.

4. The display device according to claim 1, wherein the low-refractive layer includes polymer, monomer, and an additive, and the polymer includes fluorinated urethane (meth)acrylate and polysilsesquioxane compounds.

5. The display device according to claim 4, wherein the monomer includes alkyl (meth)acrylate and fluorinated (meth)acrylate.

6. The display device according to claim 4, wherein the additive is inorganic particles modified to (meth)acrylate including (per)fluoroalkyl group.

7. The display device according to claim 4, wherein the additive is hollow silica particles.

8. The display device according to claim 1, wherein the low-refractive layer extends from the second sensor area to the first sensor area.

9. The display device according to claim 1, further comprising:
an anti-reflection layer which is disposed below the low-refractive layer and the infrared transmissive layer so as to correspond to the second sensor area and has a thickness of 10 μm or smaller.

10. The display device according to claim 9, wherein the anti-reflection layer covers a rear surface and a side surface of the infrared transmissive layer.

11. The display device according to claim 9, wherein the anti-reflection layer is a plurality of inorganic thin films formed of any one or more inorganic materials, among MgF₂, CeF₂, ZrO₂, SiO₂, TiO₂, Al₂O₃, and Nb₂O₅.

12. The display device according to claim 11, wherein the anti-reflection layer has a structure in which a first inorganic thin film formed of a first inorganic material and a second inorganic thin film formed of a second inorganic material different from the first inorganic material are alternately laminated.

13. The display device according to claim 9, wherein the anti-reflection layer is formed of an organic thin film including a moth eye pattern.

14. The display device according to claim 9, wherein the anti-reflection layer extends from the second sensor area to the first sensor area.

15. The display device according to claim 9, further comprising:
an upper anti-reflection layer on a top surface of the second glass substrate corresponding to the first sensor area and the second sensor area.

16. The display device according to claim 1, wherein a difference in reflectance between the light shielding layer and the infrared transmissive layer is in a range from 2.0 to 7.0%.

17. A display device including a display area and a non-display area which encloses the display area and which includes a first sensor area and a second sensor area, the display device comprising:
a first glass substrate;
a second glass substrate disposed opposite to the first glass substrate;
a light shielding layer which is disposed on one surface of the second glass substrate so as to correspond to the non-display area and includes a plurality of holes corresponding to the first sensor area and the second sensor area;
a first sensor below the first glass substrate corresponding to the first sensor area;
a second sensor below the first glass substrate corresponding to the second sensor area;
an infrared transmissive layer on a rear surface of the first glass substrate corresponding to the second sensor area; and
an anti-reflection layer which is disposed below the first glass substrate and the infrared transmissive layer and covers a rear surface and a side surface of the infrared transmissive layer.

18. The display device according to claim 17, wherein the anti-reflection layer is a plurality of inorganic thin films formed of any one or more inorganic materials, among MgF₂, CeF₂, ZrO₂, SiO₂, TiO₂, Al₂O₃, and Nb₂O₅ or an organic thin film including a moth eye pattern.

19. The display device according to claim 17, wherein the anti-reflection layer extends from the second sensor area to the first sensor area to be in contact with a rear surface of the first glass substrate.
